(19) United States
(12) Patent Application Publication
(10) Pub. No.: US 2002/0089942 A1
(43) Pub. Date: Jul. 11, 2002

(54) Communication of data

(76) Inventors: Matti Seppa, Jyvaskyla (FI); Ilpo Paltemaa, Espoo (FI); Teijo Roine, Laukaa (FI)

Correspondence Address: Docket Clerk, P.O. Box 802432, Dallas, TX, 75380, US

(21) Appl. No.: 09/996,160

(22) Filed: Nov. 26, 2001

(30) Foreign Application Priority Data
Nov. 30, 2000 (GB) 0029274.8

(51) Int. Cl. H04B 7/00

(52) U.S. Cl. 370/310; 370/338; 370/349

(57) ABSTRACT

The present invention relates to data communication systems. In the disclosed method a data channel is first activated between a first and a second station. A timer function is started so as to control the state of the data channel. The data channel is maintained in a ready state at least until the timer function indicates an expiry of a predefined period. The arrangement is such that after a data transmission is initiated on the data channel the state of the data channel is prevented to be changed from the ready state to another state based on the timer function. The change is allowed only after a predefined event occurs. The system may be provided with a further timer that is implemented in a lower function layer than said timer function.

### FIELD OF THE INVENTION

The present invention relates to communication of data, and in particular, but not exclusively, to data transmissions over an air interface in a communication system.

### BACKGROUND OF THE INVENTION

Communication systems typically operate in accordance with a given standard or specification which sets out what the various elements of the system are permitted to do and how that should be achieved. For example, the standard or specification may define if the user, or more precisely, user equipment or terminal is provided with a circuit switched service and/or a packet switched service. Communication protocols and/or parameters which shall be used for the connection may also be defined. In other words, a specific set of “rules” on which the communication can be based on needs to be defined to enable communication in the system.

A communication system may be capable of providing wireless packet switched services for a mobile station. Examples of such systems include the General Packet Radio Service (GPRS), the Enhanced Data rate for GSM Evolution (EDGE) mobile data network, the third generation (3G) telecommunication systems such as the Universal Mobile Telecommunication System (UMTS) or IMT-2000 and the TErrestrial Trunked Radio (TETRA) system. The TETRA is an open digital professional mobile radio standard that is especially designed for professional use, such as to be used by public authorities, business organisations and similar users. Examples of the TETRA users include police, public safety and health authorities and big companies. A feature of the TETRA is that after a data communication link has been established it may be kept continuously open. That is, after establishment of the data link it is not necessary to dial up a data connection to be able to communicate data between two or more terminals. The technical specifications for a TETRA system are defined more particularly by the ETSI (European Telecommunications Standard Institute).

The International Organisation for Standardisation (ISO) has developed a model that enables data communication systems from different manufactures to communicate with each other. The OSI model is based on a division of different functions that associate with the communication into hierarchically arranged function layers. In general terms, seven communication function layers are defined, the layers comprising a physical layer (L1), a link layer (L2), a network layer (L3), a transport layer (L4), a session layer (L5), a presentation layer (L6) and an application layer (L7). Layers L1 to L3 of the OSI model are the most relevant layers in the context of data bearer services as for TETRA packet data.

In a typical radio communication system a base (transceiver) station (BTS) serves mobile stations (MS) or similar user equipment via a wireless interface. The wireless i.e. air interface is adapted to provide at least one communication channel between the mobile station and the base station. A plurality of base stations is typically provided for a communication system. The operation of a base station is controlled by one or more controllers. The controllers may control the operation of the system in several function layers. For example, each base station may be provided with a base station controller. The operation of the base station controller may in turn be controlled by a network controller controlling the operation of several base stations and so on. The system may also be provided with one or more gateways for connecting the radio network to other networks, such as to a circuit or packet switched telephone network or a data network, such as an Internet Protocol (IP) or X.25 based data network.

Data may be transmitted between the base station and the mobile station in a data transmission entity referred to as a protocol data unit (PDU). The protocol data units may be transferred in the system based on an appropriate data transportation protocol, such as the Packet Data Protocol (PDP).

In the PDP based systems the data is transported on a packet data channel by means of so called PDP context. The PDP context is a unique relation between a upper protocol layer address (e.g. an IP address), the subscriber identity and network layer service access point identity in both a Switching and Management Infrastructure (SwMI) and a mobile station (MS). The PDP context is established for each PDP address which is active on the network. The PDP context typically refers to the part of the data connection or data bearer that goes through the packet switched system. The PDP context can be seen as a logical connection between the mobile station and another entity connected in the network or an access point of the gateway node. The PDP context may also be referred to, instead of the term logical connection, as a logical association between two termination points. A packet data channel can typically be established only after establishment of the PDP context.

For example, the current version for TETRA Air Interface standard (ETS 300 392-2 edition 2) defines a SubNetwork Dependent Convergence Protocol (SNDCP) for negotiating and maintaining the packet data protocol (PDP) contexts between a mobile station (MS) and a Switching and Management Infrastructure (SwMI) on the network side. The SNDCP may also be used for control functions that are associated with data transportation over the wireless interface between the mobile station and the network apparatus. The SNDCP is a TETRA specific network layer protocol defining TETRA packet data operations.

In the OSI model the SNDCP is a layer 3 (L3) functionality. The SwMI may be implemented by means of appropriate controllers implemented in the network. At least a part of the SwMI functions can be implemented on the 2^{nd} function layer of the OSI model. The SwMI hardware may be located in the access network (AN) side or in the core network (CN) side. The SwMI functions may also be split between the access and core network controllers.

The SNDCP based control functions that relate to a TETRA compatible mobile station (MS) are characterised by a so called internal state machine or state model. Each state describes a certain level of functionality and information allocated to the entities involved in the operation. In a so called ‘READY’ state, the mobile station and other entities are provided with at least one activated PDP context and the entities may receive and transmit datagrams. The READY state typically implies that a mobile station is located on a packet data channel and is currently engaged in data transfer or has at least recently been engaged in packet data transfer.

When the mobile station is in the READY state, the mobile station is directed to a such communication channel that is capable for packet data transmission. This channel will be referred herein to as a packet data channel (PDCH). A packet data channel (PDCH) is typically an assigned secondary control channel that can be used for transfer of packet data.

The data may be transferred by means of subnetwork protocol data units (SN-PDU). In a typical TETRA application each SN-PDU corresponds the original protocol data unit but is provided with a TETRA specific header. Before transmission over the air interface the SN-PDU can be divided into smaller entities i.e. segments. For example, the original datagram such as an Internet Protocol (IP) packet may be divided into several segments for the wireless transmission. The segments are received and combined at the receiving peer end to obtain original the datagram. Typically the combining is done after all segments are received.

The current TETRA applications and TETRA Interoperability Profile (TIP) agreements are based on the requirements set by the mobile station, such as a packet data capable type C mobile station. One of the consequences of this is that it is not possible to set-up, accept or conduct a normal circuit switched mode speech or data call if the mobile station (MS) is in the READY state. In other words, any normal circuit switched speech/data transportation is blocked for the mobile station while the mobile station is in the READY state.

The time the mobile station remains in the READY state is defined by means of a timer function. This timer function will be referred to herein as a READY timer. The READY timer is a L3 function in the OSI model. Physically a timer function is provided typically both in the mobile station and in the network side. The timer should not expire before all segments of the datagram are received.

The READY timer is started each time a datagram is transmitted. The READY timer will then run for a predefined period regardless what happens during the transmission. That is, events occurring during the proceeding of a datagram transmission in a lower layer cannot influence (e.g. stop or reset) the operation of the READY timer implemented on a higher layer of the communication function model. The same applies to an establishment of a logical link control (LLC) advanced link that is may be employed in the data transmission. The term ‘advanced link’ refers to a link layer protocol that can be used for the division of the PDU into segments, for transferring of the segments over the air interface and for compiling of the segments back into a protocol data unit at the receiving end. The only information the SNDCP level of the communication function model receives is an indication whether the transmission or reception of a whole datagram was successful or not. The READY timer may be reset only after the reception of this indication at the SNDCP level.

For example, in the current communication specifications such as the TETRA Air Interface standard the READY timer can be reset only in the following three instances:

1) When a PDP datagram has been transmitted successfully or received by the mobile station or SwMI. The successful transmission may be indicated by a reception of a ‘MLE-REPORT’ message from a mobile link entity (MLE). The MLE is a layer 3 function, forming a means for providing a link between the 2^{nd} and 3^{rd} layers of the OSI model; or

2) when a ‘SN-DATA TRANSMIT RESPONSE PDU’ message including a parameter ‘Accept/Reject=1’ is transmitted from the SwMI or received at the mobile station; or

3) when a ‘SN-DATA TRANSMIT REQUEST PDU’ message is transmitted from the SwMI or received at the mobile station.

Since the duration of the READY state is controlled by the L3 timer it is not possible for the lower layer functions to influence the duration of the READY state. That is, the timer will run until its expiry and the READY state will be maintained until said expiry regardless the events occurring on the lower layers. In addition, the reset of the timer function at end of the transmission means that the timer will start from the beginning. This is accomplished in order to ensure that all data segments belonging to the datagram are received at the receiver. Another reason for this is to wait for a predefined period to see if another datagram is to be received.

The duration of the READY timer period is defined based on a READY timer value. The READY timer value can be defined only during the PDP context activation procedure. On the other hand, the PDP context is typically kept active most of the time. Since the timer value can be changed only during the context activation proceedings, this means that the timer value cannot be changed very often. Thus, if the PDP context is kept active e.g. for the entire working day, the timer value must be set in accordance with the longest possible datagrams to be transmitted during that day. In a typical application the PDP context is activated only when it is needed for the first time and then the context is kept in the active state to optimise the next data transfer set-up proceedings.

Instead of always communicating datagrams of a predefined length, the packet data communication systems may be used to transfer both substantially short as well as substantially long data units or datagrams. For example, in applications where a mobile station is adapted to provide data for the purposes of the so called location services (LCS), only relatively short LCS datagrams may be sent over the air interface. At the same time the packet data bearer service can be used for other purposes requiring transmission of substantially long datagrams. For example, datagrams that relate to database queries, web browsing, Voice over the Internet Protocol calls (VoIP), file transfers and so on may be transferred over the air interface. The difference in the transmission times of the datagrams may be even greater in weak radio coverage conditions where the probability for LLC retransmissions is increased.

At present the READY timer is typically set in accordance with the longest possible datagrams. Therefore the current specifications typically specify that the READY timer value has to be set according to the worst case i.e. according to the longest datagrams which are possibly sent over the air interface. However, since the duration of data transmissions may vary substantially according to the length of the datagrams, it may be at least difficult if not impossible to optimise the length of the timer period. In addition, the time the READY timer is on after the receipt of the last segment in order to ensure that all segments have been received may also unnecessarily consume the communication resources of the system.

Based on the above reasons it is not always possible to optimise the time the mobile station stays on the packet data channel. If the READY timer value is set so that the READY timer period is too short for the substantially long datagrams, the packet data channel is released by the L3 timer function before the entire datagram is successfully sent over the air interface. Thus it is possible that a part of the information is lost and/or that the data communication applications may not otherwise work properly.

On the other hand, when transmitting short datagrams data may be sent only in a fraction of the READY timer period on the air interface. Whenever the mobile station is in the READY state and thus on the packet data channel circuit switched speech or data connections can become blocked. Thus any unnecessary time spent on the READY state consumes unnecessarily the network resources. Capacity problems may also occur in those SwMI implementations where only one mobile station may be on the same packet data channel at a time.

The inventors have found that the current data communication systems such as said TETRA may not provide sufficient support for instances where the lengths of the datagrams may vary substantially. Because of the involvement of a higher communication function level in the resetting of the timer it is difficult to vary the time the mobile station stays uselessly on the packet data channel. This may result in an excessive use of the network capacity even in instances where only short datagrams are transmitted. If the length of the transferred datagrams varies a lot, this may lead to long times when nothing is actually sent on the data channel while other communication may become blocked. The useless staying on the packet data channel may hinder fast and proper operation of the system, and the user may experience substantially long waiting times. The use of the present timer arrangements may make the common use of the circuit mode and packet data services difficult (if not impossible) to implement. Therefore, because of capacity and usability reasons the useless staying on the packet data channel should be minimised. To be able to do this it would be advantageous if the value of the higher level timer could be set as short as possible.

### SUMMARY OF THE INVENTION

Embodiments of the present invention aim to address one or several of the above problems.

According to one aspect of the present invention, a method for a communication system is provided, said method comprising activation of a data channel between a first and a second station and starting of a timer function. The data channel is maintained in a ready state at least as long as the timer function indicates an expiry of a predefined period. After transmission of data on the data channel is initiated the data channel is prevented from being changed from the ready state to another state based on an indication from the timer function until a predefined event occurs.

According to another aspect of the present invention there is provided a communication system comprising a first station and a second station, wherein a data channel can be established for data communication between the stations, a timer function for provision of an indication based on which the state of a data channel established between the two stations is changed from a ready state to another state, and a control function responsive to said timer function and for controlling the state of the data channel. The arrangement is such that the data channel is prevented to change from the ready state to said other state based on the timer function until a predefined event has occurred.

According to another aspect of the present invention there is provided a station for a communication system, said station comprising communication means for establishing a data channel for data communication between the station and another station and a timer function for provision of an indication based on which the state of a data channel established between the station and said other station is to be changed from a ready state to another state. The arrangement is such that the data channel is prevented to change from the ready state to said other state based on the timer function until occurrence of a predefined event.

The embodiments of the invention may optimise the time the air interface between two stations stays on the data channel. The communication resources may be more efficiently used than in the prior art solutions. Communication in other modes and/or channels may not become as easily blocked by an activated but non-used data channel as in the prior art. It is possible to define an appropriate latency time on the data channel regardless the lengths of the datagrams. A short READY timer period does not necessarily prevent successful transmission of substantially long datagrams. Lower layer retransmission may also be enabled in a more efficient manner than in the prior art.

### BRIEF DESCRIPTION OF DRAWINGS

For better understanding of the present invention, reference will now be made by way of example to the accompanying drawings in which:

FIG. 1 shows a system in which the present invention may be employed;

FIGS. 2a and 2b illustrate events and signalling in accordance with a further embodiment of the present invention; and

FIG. 3 is a flowchart illustrating the operation in the FIG. 2b situation.

### DESCRIPTION OF PREFERRED EMBODIMENTS OF THE INVENTION

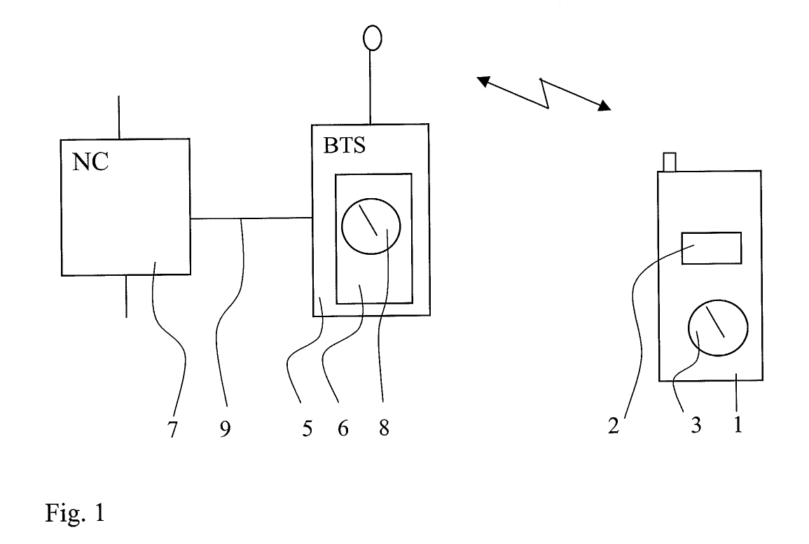

Reference is made to FIG. 1 which shows a system comprising a mobile station 1 and a base station 5 embodying the present invention. The mobile station 1 is provided with a controller unit 2. The mobile station 1 comprises also communication means for enabling establishment of radio communication channels between the mobile station and the base station 5. The communication means are known and are thus not shown or described in more detail. It is sufficient to note that the communication means typically include appropriate transceiver apparatus enabling transmission and receipt of radio frequency signals.

The mobile station 1 is shown to be in communication with the base station 5 over an air interface. The base station 5 also comprises appropriate transceiver apparatus (not shown in detail) for enabling establishment of at least one radio frequency communication channel with the mobile station 1. The operation of the base station may be controlled by a base station controller 6. The base station is connected by line 9 to a network controller element 7 controlling the operation of several base stations.

In this simplified example of the network apparatus the Switching and Management Infrastructure (SwMI) of the communication network shall be understood to be provided by the arrangement that comprises controllers 6 and 7. However, it shall be appreciated that the SwMI function may comprise one or more elements that are other than those shown by FIG. 1. It shall also be appreciated that albeit a communication system typically serves a plurality of mobile stations, and comprises a plurality of base stations and controllers, only one of each of these is shown in FIG. 1 for clarity reasons.

A timer function is provided on layer 3 (L3) of the OSI model. The timer function is adapted to provide a READY timer at both ends of the air interface link between the two stations 1 and 5. To implement this, both the mobile station 1 and the base station 5 are provided with a timer 3 and 8, respectively. The operation of a conventional OSI layer 3 READY timer functionality was explained above and will thus not be reiterated in here in all detail. It is sufficient to note that both timers 3 and 8 may be started whenever either the mobile station or the base station enters the packet data channel.

The READY timers are adapted to control the time a mobile station MS and the Switching and Management Infrastructure (SwMI) can remain in the READY state and stay on a packet data channel. The packet data channel is established on the air interface. The READY state is preferably maintained for a while even after the actual data transmission on the packet data channel (PDCH) has ended. This may be done e.g. in order to ensure that all data segments have been received and/or to confirm that no other subsequent data transmission is initiated after the transmission of the first data transmission.

Thus, it is advantageous if the packet data channel may be released only after a certain period after the end of the data transmission, e.g. based on the expiry of the READY timer. For example, the mobile station and the base station may remain in the READY state for a while even after an IP data packet i.e. datagram such as ‘SN-DATA’, or ‘SN-UNITDATA’ has been successfully transmitted between the mobile station and the SwMI. A minimum time in the READY state after these indications is preferably ensured by resetting the READY timer function, that is by starting the READY timer function from the beginning.

The mobile station 1 may be provided with a READY timer value from the SwMI during the PDP context activation procedure and the timer 3 thereof can be adjusted accordingly. The embodiments enable use of substantially short timer periods without the risk of running out of time when transmitting substantially long datagrams. Therefore the READY timer function can be set-up to run for a shorter period than what was required in the conventional timer arrangements. This shortens substantially the unnecessary READY state periods after the short datagrams as well as after the above mentioned resetting of the timer function. The following will explain possible ways of accomplishing this.

The inventors have found that instead of defining a long enough READY timer expiry time, it is more advantageous to prevent the system to drop (i.e. “cut off”) the data packet channel based on the ready state timer function. The dropping can be prevented by ignoring, stopping or pausing the READY timers 3 and 8 whenever data is transmitted of the packet data channel.

This may be accomplished such that when a Subnetwork Dependent Convergence Protocol (SNDCP) entity on the network layer (L3) starts sending a PDP datagram the SNDCP entity stops or ignores the READY timers 3 and 8 until the SNDCP entity receives an indication from a lower layer (e.g. from L2) that the transmission of the datagram was either sent successful or failed. From this indication the SNDCP entity may then restart or reset the READY timers. By means of this it is possible to arrange the READY timer function such that it does not limit the length of the data transmission over the packet data channel. This enables use of substantially short READY timer periods. In consequence the periods which the wireless interface stays on the packet data channel in instances where no data is actually transmitted over the packet data channel can also be shortened.

In other words, since the data transmissions are not dropped based on the timer value defined during the PDP context activation, there is no longer need to define a timer value that will ensure a long enough ready state for all possible datagrams. That is, only a relatively short basic READY timer period need be defined to ensure a sufficiently reliable data transmissions over the air interface.

The packed data channel (PDCH) may be released after the READY timer function indicates that a predefined time period has lapsed. Preferably the period equals with the expiry time of the timer function. The expiring timer of the timer function is preferably the timer 8 implemented in the network side. The expiry of the timer function may also be triggered by the timer 3 of the mobile station 1. In some applications it may be advantageous to wait until both timers 3 and 8 expire.

After the expiry the mobile station 1 is directed to a main control channel (MCCH). After the mobile station 1 has been returned to the main control channel, it is enabled to set-up and accept any circuit mode speech/data or TETRA Packet data calls. Since the timer periods are shortened, this should mean that the system provides more capacity for such communication.

If the transmission of the PDP datagram fails, the SNDCP entity may e.g. reset the advanced link.

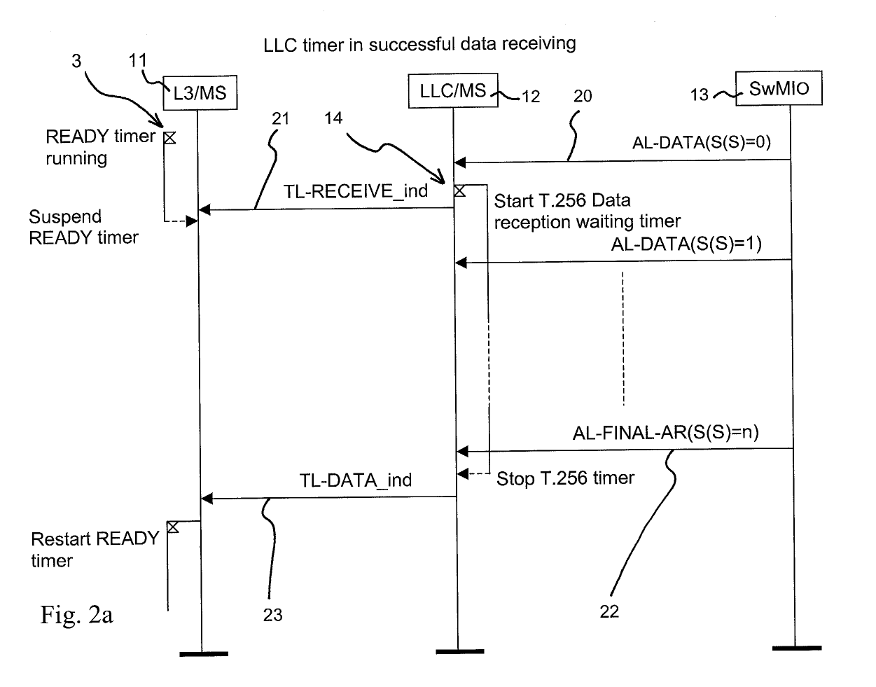

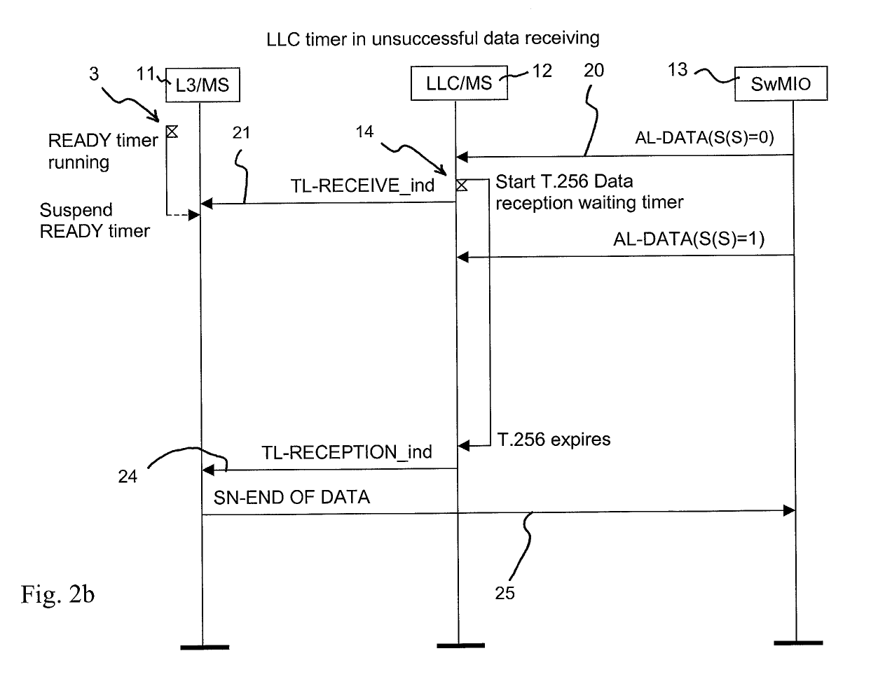

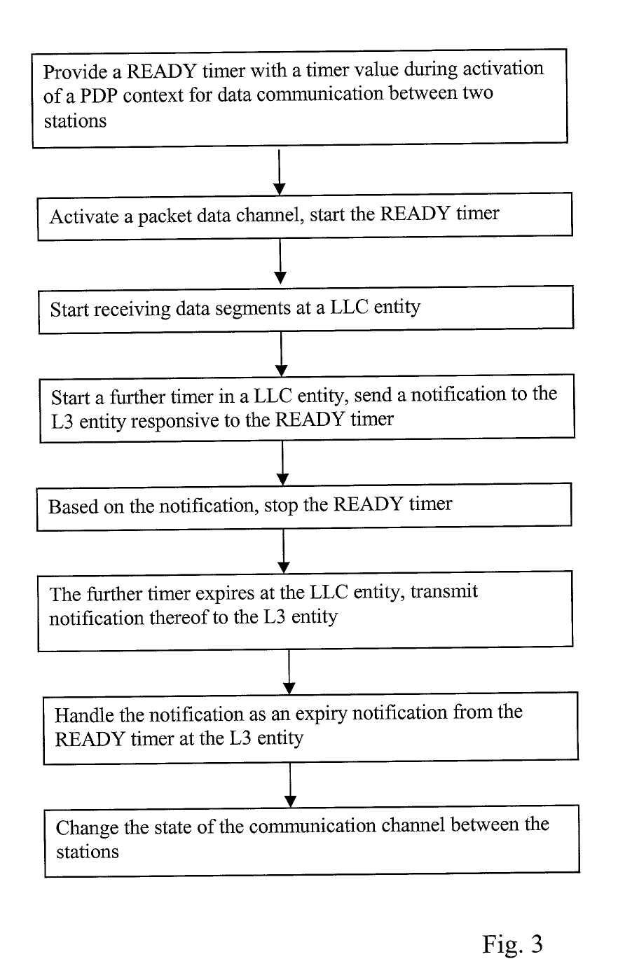

FIGS. 2a, 2b and 3 illustrate a further embodiment in which the communication system is provided with a back-up system so that the air interface does not become “forgotten” in the ready state. The embodiment employs logical link control (LLC) timer function for the provision of the back-up mechanism. The LLC is implemented on the L2 functional layer.

A mobile station is shown to comprise a layer 3 entity 11 and a layer 2 LLC entity 12. The SwMI entity 13 is implemented in the network side of the system. FIGS. 2a and 2b illustrate the signalling between entities 11 to 13 and events occurring during successful and unsuccessful data receiving, respectively, in an instance where the L2 LLC entity is provided at the mobile station.

It shall be appreciated that although not illustrated, the network side may also be provided with one or more LLC entities. A network side LLC entity may distributed between a base station and one or several network controllers.

Each L2 LLC entity 12 is adapted to receive advanced link data segments from a peer entity. The transmission of the data segments is initiated by signalling an initial message 20 (segment 0) to the LLC entity 12. The LLC entity 12 may then signal a message 21 to a SNDCP entity i.e. the L3 mobile station entity 11 as an indication that the reception of the segment of a PDP datagram has geeb started. As shown by FIGS. 2a and 2b, the L3 READY timer is suspended in response to the receipt of the message 21.

The LLC entity is also provided with a LLC timer 14 (e.g. T.256). The operation of the LLC timer 14 as a backup mechanism will now be explained with reference also to the flowchart of FIG. 3. When the logical link control (LLC) entity 12 starts to receive advanced link data segments of the datagram from the peer entity, the LLC entity 12 starts the new LLC timer 14. In response to the message 21 the SNDCP entity 11 may suspend the READY timer function 3 or alternatively simply ignore the READY timer function. The new LLC timer 14 works from this moment on as a backup mechanism.

If the reception of the data segments was successful, i.e. in the FIG. 2a situation, the LLC timer 14 is stopped after reception of the last data segment 22. The LLC entity combines the data segments to reproduce the original data packet. After this the LLC entity 12 signals a message 23 of regarding the reception to the SNDCP entity 11. The recombined data packet is included in the message 23. The L3 READY timer may then be restarted or reset in response to message 23 to provide the above discussed period after the completion of the reception of data.

FIG. 2b illustrates situation where the LLC timer 14 expires before the reception of the last segment of the IP data packet. In this case a message 24 is transmitted to the SNDCP entity 11 as an indication of the expiry of the timer 14. Since not all data segments of the datagram were received by the LLC entity, the message 24 cannot include the combined datagram. The receipt of message 24 in the SNDCP entity 11 may trigger an operation similar to that what would have been triggered by an expiry of the READY timer function 3. That is, the SNDCP entity 11 may handle the indication 24 equally to the indication of the expiry of the READY timer 3.

Since the SNDCP entity 11 interprets the message 24 as an indication of the expiry of the READY timer, a message 25 indicating the end of the data transmission may then be transmitted to the SwMI entity. For example, the SNDCP entity 11 may send a message such as ‘SN-END OF DATA PDU’ to the peer entity after the receipt of the message 24. After this the peer entity may be returned to the main control channel. Upon reception of the message 25 the SwMI entity 13 may follow any appropriate predefined procedure, depending on the application. It may, for example, start a retransmission of the data segments, produce an error message and so on.

An exemplifying value for the LLC timer 14 could be 12 signalling frames. The LLC timer 14 may have a value that is a little bit greater than the value of a LLC acknowledgement waiting timer of the transmitting party (not shown). This may enable some LLC retransmissions while still within the timer period of the acknowledgement waiting timer function. The transmitting advanced link entity acknowledgement timer (e.g. T.252) may be set to expire e.g. after nine signalling frames. This defines the time how long the transmitting entity waits for the acknowledgement of the transmitted segments.

In the current specifications the READY timer function indicates the time which is spent on the packet data channel (PDCH). By defining the timer function like suggested above the timer function may be adapted indicate the actual and optimal latency time on the PDCH. This helps to minimise the useless staying of the mobile station on the PDCH.

The READY timer function may be restart or reset also based on other events than the end of the data transmission. For example, if the timer function is controlled based on messages signalled from the transmitting station, the messages may indicate e.g. transmission of the second last, third last or so on data packets.

The embodiment may be implemented by modifications of the existing arrangement in the peer-to-peer level. Thus no changes are necessarily required to the existing air interface and/or data transmission channels between a mobile station and the network apparatus.

It should be appreciated that whilst embodiments of the present invention have been described in relation to mobile stations and base station, embodiments of the present invention are applicable to any other suitable type of user equipment and stations.

The data is described as being in packet form. In alternative embodiments of the invention the data may be sent in any suitable format.

The embodiment of the present invention has been described in the context of a TETRA system. This invention is also applicable to any other standard wherein the time a station may stay on a data channel is controlled by means of a timer function.

It is also noted herein that while the above describes exemplifying embodiments of the invention, there are several variations and modifications which may be made to the disclosed solution without departing from the scope of the present invention as defined in the appended claims.

1. A method in a communication system comprising:
activating a data channel between a first and a second station;
starting a timer function;
maintaining the data channel in a ready state until the timer function indicates an expiry of a predefined period;
initiating transmission of data on the data channel; and
preventing the data channel to change from the ready state to another state based on the timer function until a predefined event.

2. A method as claimed in claim 1, wherein at least one timer of the timer function is stopped until an indication of the event.

3. A method as claimed in claim 2, wherein the at least one timer of the timer function is reset upon receipt of said indication.

4. A method as claimed in claim 2, wherein the at least one timer of the timer function is restarted in response to said indication.

5. A method as claimed in claim 1, wherein the timer function is ignored until an indication of the event.

6. A method as claimed in claim 1, wherein the timer function is reset in response to an indication of the event.

7. A method as claimed in claim 1, wherein the event comprises an indication that the data transmission has ended.

8. A method as claimed in claim 1, wherein the timer function is prevented to have impact on the state of the data channel during the data transmission.

9. A method as claimed in claim 1, wherein the length of said predefined period is set during the activation of the data channel based on a timer value.

10. A method as claimed in claim 1, wherein the state of the data channel is changed to said other state based on an indication by a further timer.

11. A method as claimed in claim 10, wherein the further timer is implemented by a logical link control function.

12. A method as claimed in claim 10, wherein an indication of the expiry of the further timer is handled by the system as it would be an indication from the timer function.

13. A method as claimed in claim 1, wherein the first station comprises a mobile station and the second station comprises a base station of a cellular communication system.

14. A method as claimed in claim 1, wherein a data channel that is in the ready state prevents communication over another channel between the two stations.

15. A method as claimed in claim 1, wherein the communication system is based on a TErrestrial Trunked Radio (TETRA) standard or similar.

16. A communication system comprising:
a first station and a second station, wherein a data channel can be established for data communication between the stations;
a timer function for provision of an indication based on which the state of a data channel established between the two stations is changed from a ready state to another state; and
a control function responsive to said timer function and for controlling the state of the data channel, the arrangement being such that the data channel is prevented to change from the ready state to said other state based on the timer function until a predefined event has occurred.

17. A communication system as claimed in claim 16, wherein the timer function comprises at least one timer that can be stopped until occurrence of the predefined event.

18. A communication system as claimed in claim 17, wherein the timer function is ignored until the occurrence of the event.

19. A communication system as claimed in claim 16, wherein the timer function comprises at least one timer that can be restarted in response to an indication of the occurrence of the event.

20. A communication system as claimed in claim 16, wherein the timer function is adapted to be reset in response to an indication that the event has occurred.

21. A communication system as claimed in claim 16, wherein the event comprises an indication that data transmission is completed.

22. A communication system as claimed in claim 16, wherein the timer function is implemented on such a layer of a connection function model that is higher than a layer of said model on which the data communication functionality is handled.

23. A communication system as claimed in claim 16, comprising a further timer implemented in a lower function layer of a connection function model than on which said timer function is implemented.

24. A communication system as claimed in claim 23, wherein the further timer is implemented in a logical link control entity.

25. A communication system as claimed in claim 23, wherein the controller is adapted to handle an indication of the expiry of the further timer as it would be an indication from the timer function.

26. A communication system as claimed in claim 16, wherein the first station comprises a mobile station and the second station comprises a base station of a cellular communication system.

27. A communication system as claimed in claim 26, wherein the communication system is based on a TErrestrial Trunked Radio (TETRA) standard or similar.

28. A station for a communication system, said station comprising:
communication means for establishing a data channel for data communication between the station and another station;
a timer function for provision of an indication based on which the state of a data channel established between the station and said other station is to be changed from a ready state to another state, wherein the arrangement is such that the data channel is prevented to change from the ready state to said other state based on the timer function until occurrence of a predefined event.
